(19) United States
(12) Patent Application Publication
(10) Pub. No.: US 2026/0105333 A1
(43) Pub. Date: Apr. 16, 2026

(54) METHOD AND SYSTEM FOR PROVIDING AI AGENT BASED ON LLM APPLYING ARTIFICIAL INTELLIGENCE MODEL INCLUDING PLURALITY OF MODELS

(71) Applicant: LG MANAGEMENT DEVELOPMENT INSTITUTE CO., LTD., Seoul (KR)

(72) Inventor: Ye Muk CHOI, Seoul (KR)

(21) Appl. No.: 19/422,354

(22) Filed: Dec. 16, 2025

Related U.S. Application Data
(63) Continuation of application No. PCT/KR2025/006679, filed on May 16, 2025.

(30) Foreign Application Priority Data
May 17, 2024 (KR) 10-2024-0064556

(51) Int. Cl. G06N 5/043

(52) U.S. Cl. CPC G06N 5/043

(57) ABSTRACT

A method for providing an artificial intelligence (AI) agent based on a large language model (LLM) applying an artificial intelligence model including a plurality of models includes: executing an on-device AI agent service; acquiring predetermined input data based on the executed on-device AI agent service; determining a domain according to the acquired input data; deciding an application model, which is an AI model that will process a task according to the determined domain; generating output data for the input data based on the decided application model; and providing the generated output data based on the on-device AI agent service.

### CROSS-REFERENCE TO RELATED APPLICATIONS

This application is a continuation of International Patent Application No. PCT/KR2025/006679, filed on May 17, 2025, which claims the benefit of and priority to Korean Patent Application No. 10-2024-0064556, filed on May 17, 2024, the entire disclosures of which are hereby incorporated herein by reference in their entireties.

### BACKGROUND

### Technical Field

The present disclosure generally relates to a method and system for providing an artificial intelligence (AI) agent based on a large language model (LLM) applying an AI model including a plurality of models. More specifically, some embodiments of the present disclosure relate to a method and system for providing an on-device specialized AI agent that decides an application model optimized for a domain according to an external environment based on an LLM that applies mixture of experts (MoE) and performs output based on the decided application model.

### Related Art

In general, artificial intelligence (AI) is implemented through multiple AI models and deep learning based thereon.

The AI is being developed to provide a variety of services in consideration of the user's context (for example, context, environment and/or intents).

However, when specific tasks are intended to be processed based on large amounts of data, computational cost or time required for processing these tasks are considerable.

As a result, in recent years, there are also limitations on using AI models in on-device environments.

In order to address this limitation, model architecture such as mixture of experts (MoE) is utilized in the related art.

The MoE may refer to architecture of a machine learning model which addresses complex issues by combining multiple expert models.

The MoE may include expert models, which are several small networks designed to learn different portions and/or different features of predetermined data, and perform resulting data processing operation, and a gating network which evaluates the performance of each expert model, and decides which expert model is most suitable for a specific task according to predetermined data.

Accordingly, according to the MoE architecture, the gating network which acquires predetermined input data decides probabilistic or decisive task allocation for each expert model, and selected expert models perform individual tasks and return results thereof to perform data processing for a specific task.

As the MOE is utilized, the AI model allocates computational resources by activating only a specific portion when a complicated task or a large quantity of datasets in order to improve overall efficiency and performance.

However, in the related art, to perform the operation using the MOE, a high-level video random access memory (VRAM) may be required, and a subject matter to be addressed in a fine tuning process may be also considerable.

In addition, the MoE may be used in the related art to efficiently manage a large size model, but may be limited in supporting the efficiency of the rest of the resources that are not activated according to the given task.

In addition, in the technical field of the related art, a service may be provided by using the AI model implemented mostly, and it may be difficult to quickly and easily secure the AI analysis performance that is most suitable for a given context.

### SUMMARY

An aspect of the present disclosure may be directed to a method and system for providing an on-device specialized artificial Intelligence (AI) agent configured to decide an application model optimized for a domain according to external environment based on a large language model (LLM) that applies mixture of experts (MoE) and performs output based on the decided application model.

Technical aspects to be achieved by the present disclosure and embodiments according to the present disclosure are not limited to the technical aspects described above, and other technical aspects may also be addressed.

A method for providing an AI agent based on an LLM applying an artificial intelligence model including a plurality of models according to an embodiment of the present disclosure pertains to a method for a computing system including a memory and a processor to provide an AI agent based on an LLM applying an artificial intelligence model including a plurality of models, wherein the method includes: executing an on-device AI agent service; acquiring predetermined input data based on the executed on-device AI agent service; determining a domain according to the acquired input data; deciding an application model, which is an artificial intelligence model that will process a task according to the determined domain; generating output data for the input data based on the decided application model; and providing the generated output data based on the on-device AI agent service.

In another aspect, the input data specifies the task according to the domain in the form of at least one of predetermined text, voice, image, video, or sensing data.

In another aspect, the domain specifies at least one feature of data, a rule, a terminology, a problem definition, or a process for a predetermined task.

In another aspect, the decision of the application model includes deciding at least one application model based on a master model that controls the operation of an on-device AI agent service system.

In another aspect, the master model includes at least one of a router (gating network), which is an artificial intelligence module that performs task allocation for each artificial intelligence model included in the on-device AI agent service system based on the decided domain, or an orchestrator, which is an artificial intelligence module that controls the router.

In another aspect, the decision of the application model further includes deciding the application model based on a secondary model, which is an artificial intelligence module that performs a predetermined task under the control of the master model.

In another aspect, the secondary model includes at least one of a small large language model (sLLM), normal mixture of experts (MoE) model, external model, or specialized model (SM).

In another aspect, the sLLM includes an MoELM, which is a model based on an MoE architecture, constructed by combining the specialized model, which is an independently pre-trained artificial intelligence model, and the router, which is an artificial intelligence module that controls a model task.

In another aspect, the specialized model includes an specialized module model, which is an independently modularized specialized model, matched with specialized model feature information acquired based on predetermined MoE architecture-based learning.

In another aspect, the sLLM includes a DMoE model, which is a model based on an MoE architecture, constructed by combining the specialized module model and the router.

In another aspect, the decision of the application model further includes detecting the secondary model optimized for task processing according to the domain based on the master model, and deciding the detected secondary model as the application model.

A system for providing an AI agent based on an LLM applying an artificial intelligence model including a plurality of models according to an embodiment of the present disclosure includes: at least one memory; and at least one processor for reading out at least one application stored in the memory and providing the AI agent based on the LLM applying the artificial intelligence model including the plurality of models, wherein instructions of the processor include instructions for: executing an on-device AI agent service; acquiring predetermined input data based on the executed on-device AI agent service; determining a domain according to the acquired input data; deciding an application model, which is an artificial intelligence model that will process a task according to the determined domain; generating output data for the input data based on the decided application model; and providing the generated output data based on the on-device AI agent service.

A method and system for providing an AI agent based on an LLM applying an artificial intelligence model including a plurality of models according to an embodiment of the present disclosure can effectively decide a model optimized for data processing according to a given domain even in an on-device environment based on an AI agent model including models implemented by applying an MoE architecture, and provide an output according to efficient data processing through the decided model.

Further, a method and system for providing an AI agent based on an LLM applying an artificial intelligence model including the plurality of models according to an embodiment of the present disclosure can implement and provide an artificial intelligence model that is capable of better understanding, executing, and responding to a given task even in any environment, and can significantly improve qualities and performances of various services based thereon (for example, smart phone's voice assistant services, smart camera services, fitness tracker and smartwatch services, autonomous driving services, and/or home security services).

The effects of the present disclosure are not limited to those mentioned above, and other effects not mentioned may be clearly understood by those skilled in the art from the following description.

### BRIEF DESCRIPTION OF DRAWINGS

FIG. 1 illustrates a block diagram of a computing system implementing an MoE architecture-based model provision service according to an embodiment of the present disclosure.

FIG. 2 illustrates a block diagram of a computing device implementing an MoE architecture-based model provision service according to an embodiment of the present disclosure.

FIG. 3 illustrates a block diagram of a computing device implementing an MoE architecture-based model provision service according to an embodiment of the present disclosure.

FIG. 4 illustrates a block diagram of an AI agent model according to an embodiment of the present disclosure.

FIG. 5 illustrates a flowchart of a method of providing an MoE model according to an embodiment of the present disclosure.

FIG. 6 illustrates a conceptual diagram of a method of providing an MoE model method according to an embodiment of the present disclosure.

FIG. 7 illustrates a flowchart of a method of specifying a model based on an MoE according to an embodiment of the present disclosure.

FIG. 8 illustrates a conceptual diagram of a method of specifying a model based on an MoE according to an embodiment of the present disclosure.

FIG. 9 illustrates an example of specialized model feature information according to an embodiment of the present disclosure.

FIG. 10 illustrates a flowchart of a method for providing an AI agent based on an LLM applying an MoE according to an embodiment of the present disclosure.

FIG. 11 illustrates a conceptual diagram of a method for providing an AI agent based on an LLM applying an MoE according to an embodiment of the present disclosure.

### DETAILED DESCRIPTION OF EMBODIMENTS

Embodiments can impose various transformations that can have various embodiments, and specific embodiments illustrated in the drawings will be described in detail in the detailed description. The advantages, features and methods for achieving the same will become apparent from the following description of the embodiments given in conjunction with the accompanying drawings. However, the present disclosure is not limited to the embodiments described herein but may be embodied in many different forms. It will be understood that, although the terms “first” or “second” may be used herein to distinguish one component from another component, these components should not be limited by these terms. In addition, a singular expression includes a plural expression, unless the context clearly states otherwise. In addition, it should be understood that the terms such as “include” or “have” are merely intended to indicate that features, or components described in the specification are present, and are not intended to exclude the possibility that one or more other features, or components will be added. In addition, components in the drawings may be exaggerated or shrunk for the convenience of descriptions. For example, since the size and thickness of each element in the drawings has been arbitrarily modified for the convenience of descriptions, it should be noted that the present disclosure is not necessarily limited to what has been shown in the drawings.

Hereinafter, embodiments of the present disclosure will be described in detail with reference to appended drawings. Throughout the specification, the same or corresponding component is assigned the same reference numeral, and repeated descriptions thereof will be omitted.

### System Implementing MoE Architecture-Based Model Provision Service

Hereinafter, a system for implementing a model provision service based on a mixture of experts (MoE) architecture configured to decide an application model optimized for a domain according to an external environment based on a large language model (LLM) applying the MoE and provide an on-device specialized artificial intelligence (AI) agent configured to perform output based on the decided application model according to some embodiments of the present disclosure will be described in detail with reference to the accompanying drawings.

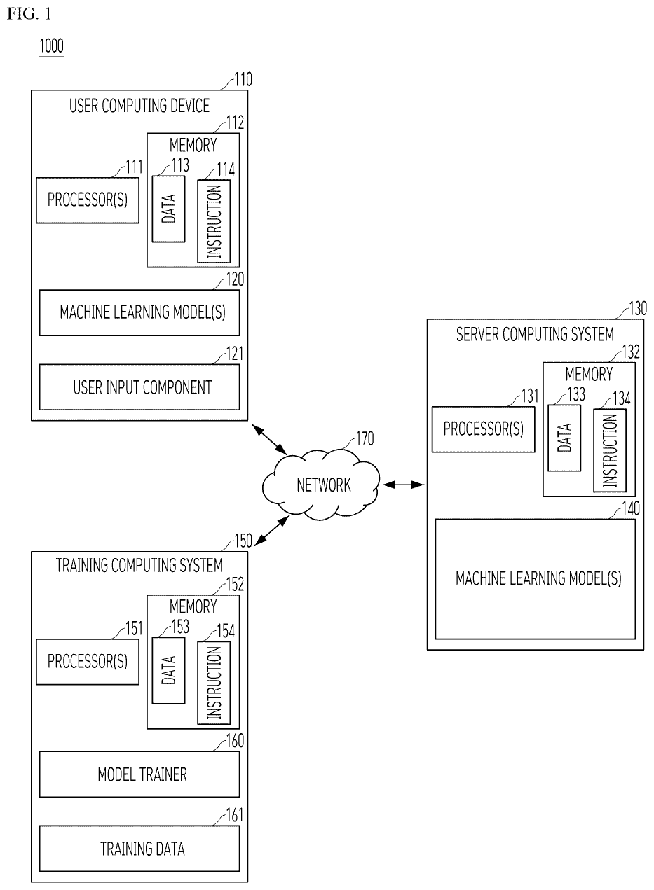

FIG. 1 illustrates a block diagram of a computing system implementing an MoE architecture-based model provision service according to an embodiment of the present disclosure.

Referring to FIG. 1, a computing system or computer 1000 which implements the MoE architecture-based model provision service according to an embodiment of the present disclosure includes a user computing device or user computer 110, a server computing system or server 130, and a training computing system or training computer 150, and any other devices which are configured to communicate through a network 170.

The MoE architecture-based model provision service according to an embodiment of the present disclosure that decides an application model optimized for a domain according to external environment based on an LLM applying the MoE and provides an on-device specialized AI agent that performs output based on the decided application model may (1) be implemented and provided locally by the user computing device 110, (2) implemented and provided in the form of a web service by the server computing system 130 which communicates with the user computing device 110, and (3) implemented and provided by association or combination of the user computing device 110 and the server computing system 130.

In an embodiment, the user computing device 110 and/or the server computing system 130 may train a machine learning model 120 and/or 140 through interaction with the training computing system 150 communicationally connected through the network 170. The training computing system 150 may be a system separated from the server computing system 130 or may be included or a portion of the server computing system 130.

In addition, the artificial intelligence model may be (1) directly trained locally by the user computing device 110, (2) trained while the server computing system 130 and the user computing device 110 interact with each other through the network 170, and (3) trained by using various training techniques and learning techniques by the separate training computing system 150. In addition, the artificial intelligence model trained by the training computing system 150 may be transmitted to the user computing device 110 and/or the server computing system 130 through the network 170, and is updated by the user computing device 110 and/or the server computing system 130.

In some embodiments, the training computing system 150 may be included in or a portion of the server computing system 130 or be included in or a portion of the user computing device 110.

The user computing device 110 may include various types of computing devices or computers such as a smart phone, a cellular phone, a digital broadcasting device, personal digital assistants (PDA), a portable multimedia player (PMP), a desktop, a wearable device, an embedded computing device, and/or a tablet personal computer (PC).

The user computing device 110 includes one or more processors 111 and memory 112. The processor 111 may be configured of one or the plurality of processors electrically or communicationally connected and may include, for example, but not limited to, one or more of a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions.

The memory 112 may include one or more non-transitory and/or transitory computer-readable storage media, such as Random Access Memory (RAM), Read-Only Memory (ROM), Electrically Erasable Programmable Read-Only Memory (EEPROM), Erasable Programmable Read-Only Memory (EPROM), flash memory devices, or magnetic disks, and combinations thereof, and may include web storage of servers performing storage functions of the memory on the Internet. The memory 112 may store data 113 and instructions 114 which are necessary for or executable by the processor 111 to perform a functional operation, such as training the artificial intelligence model or executing the MoE architecture-based model provision service through the artificial intelligence model.

In an embodiment, the user computing device 110 may store at least one machine learning model 120.

Specifically, the user computing device 110 may include various machine learning models such as a plurality of neural networks (for example, deep neural networks) or other types of machine learning models, including non-linear models and/or linear models, and may be configured of a combination thereof.

The neural network may include at least one of feed-forward neural networks, recurrent neural networks (for example, long short-term memory recurrent neural networks), convolutional neural networks and/or other forms of neural networks.

In an embodiment, the user computing device 110 may receive at least one machine learning model 120 from the server computing system 130 via the network 170, store the machine learning model 120 in the memory 112, and then execute the stored machine learning model 120 by the processor 111 to perform the MoE architecture-based model provision service.

In another embodiment, the server computing system 130 may include at least one machine learning model 140 and perform operations through the machine learning model 140, and may provide the MoE architecture-based model provision service to a user in association with the user computing device 110 in a manner of communicating data with the user computing device 110.

For example, the user computing device 110 may perform the MoE architecture-based model provision service by providing an output for the input of a user using the machine learning model 140 through the server computing system 130 via the web.

In addition, the artificial intelligence model may also be implemented in such a way that at least some of the machine learning models 120 and/or 140 are executed on the user computing device 110 and the rest of the machine learning models 120 and/or 140 are executed on the server computing system 130.

In addition, the user computing device 110 may include at least one input component 121 configured to detect user input. For example, the user input component 121 may include a touch sensor (for example, a touch screen and/or a touch pad) that detects touch of an input medium of a user (for example, a finger or a stylus), an image sensor that detects a motion input of a user, a microphone that detects user voice input, a button, a mouse and/or a keyboard. In addition, the user input component 121 may include an interface, and may receive input from an external controller (for example, a mouse or a keyboard) through the interface.

The server computing system 130 includes at least one processor 131 and a memory 132. The processor 131 may be configured of at least one or a plurality of processors electrically or communicationally connected and may include, for example, but not limited to, one or more of a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions.

In addition, the memory 132 may include one or more non-transitory and/or transitory computer-readable storage media, such as RAM, ROM, EEPROM, EPROM, flash memory devices, or magnetic disks, and combinations thereof. The memory 132 may store data 133 and instructions 134 which are required for or executable by the processors 131 to perform a functional operation such as the train of the artificial intelligence model or the execution of the MoE architecture-based model provision service through the artificial intelligence model.

In an embodiment, the server computing system 130 may include one or more computing devices or computers. For example, the server computing system 130 may be implemented so that a plurality of computing devices operate according to sequential computing architecture, parallel computing architecture, or a combination thereof. Further, the server computing system 130 may include a plurality of computing devices connected through the network 170.

Further, the server computing device 130 may store one or more machine learning models 140. For example, the server computing system 130 may include a neural network and/or multilayer non-linear model as the machine learning model 140. For example, neural network may include a feed-forward neural network, a deep neural network, a recurrent neural network, and a convolution neural network.

The training computing system 150 includes at least one processor 151 and a memory 152. The processor 151 may be configured of at least one or a plurality of processors electrically or communicationally connected, and the processor 151 may comprise, for example, but not limited to, one or more of the CPU, the GPU, the ASICs, the DSPs, the DSPDs, the PLDs, the FPGAs, controllers, micro-controllers, microprocessors, and/or other electrical units for performing functions.

In addition, the memory 152 may include one or more non-transitory and/or transitory computer-readable storage media, such as RAM, ROM, EEPROM, EPROM, flash memory devices, or magnetic disks, and combinations thereof, and may include web storage of servers performing storage functions of the memory on the Internet. The memory 152 may store data 153 and instructions 154 which are necessary for or executable by the processor 151 to perform the training of the artificial intelligence model.

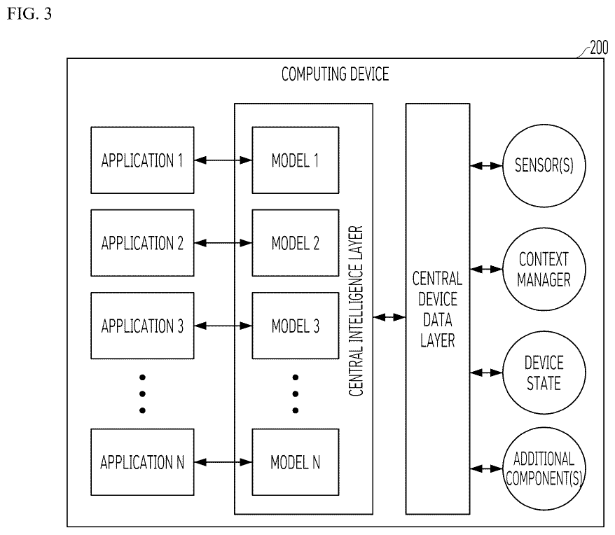

For example, the training computing system 150 may include a model trainer 160 configured to train the machine learning models 120 and/or 140 stored in the user computing device 110 and/or the server computing system 130 by using various training or learning techniques such as backpropagation of an error (according to the framework illustrated in FIG. 3).

For example, the model trainer 160 may update one or more parameters of the machine learning models 120 and/or 140 based on a defined loss function by a backpropagation scheme.

In some embodiments, the performance of the backpropagation of the error may include performing truncated backpropagation through time. The model trainer 160 may perform multiple generalization techniques (for example, weight reduction, drop-out, and/or knowledge distillation) in order to enhance a generalization capability of the trained machine learning models 120 and/or 140.

In particular, the model trainer 160 may train the machine learning models 120 and/or 140 based on a series of training data 161. The training data 161 may include, for example, different formats of data such as an image, an audio, and/or text. Examples of image type data which may be used may include a video frame, LiDAR point cloud, an X-ray image, a computer tomography scan, a hyperspectral image, and/or various other types of images.

The training data 161 may be provided by the user computing device 110 and/or the server computing system 130. When the training computing device 150 trains the machine learning models 120 and/or 140 with respect to specific data of the user computing device 110, the machine learning models 120 and/or 140 may be characterized as a personalized model.

In addition, the model trainer 160 includes a computer logic utilized to provide a desired function.

Further, the model trainer 160 may be implemented as hardware, firmware, and/or software controlling a universal processor. In one embodiment, the model trainer 160 may include a program file stored in a storage device, and may be loaded to the memory 152 and executed by one or more processors 151. In another embodiment, the model trainer 160 includes one or more sets of computer-executable data 153 and instructions 154 stored in a tangible computer-readable storage medium such as a RAM hard disk or an optical or magnetic medium.

The network 170 includes a 3rd Generation Partnership Project (3GPP) network, a Long Term Evolution (LTE) network, a World Interoperability for Microwave Access (WIMAX) network, Internet, a Local Area Network (LAN), Wireless Local Area Network (LAN), a Wide Area Network (WAN), a Personal Area Network (PAN), a Bluetooth network, a satellite broadcasting network, an analog broadcasting network, and/or a Digital Multimedia Broadcasting (DMB) network, but is not limited thereto.

In general, communication through the network 170 may be performed through various communication protocols (for example, TCP/IP, HTTP, SMTP, and/or FTP), encoding or formats (for example, HTML and/or XML), and/or protective schemas (for example, VPN, secure HTTP, and/or SSL) by using any type of wired and/or wireless communication.

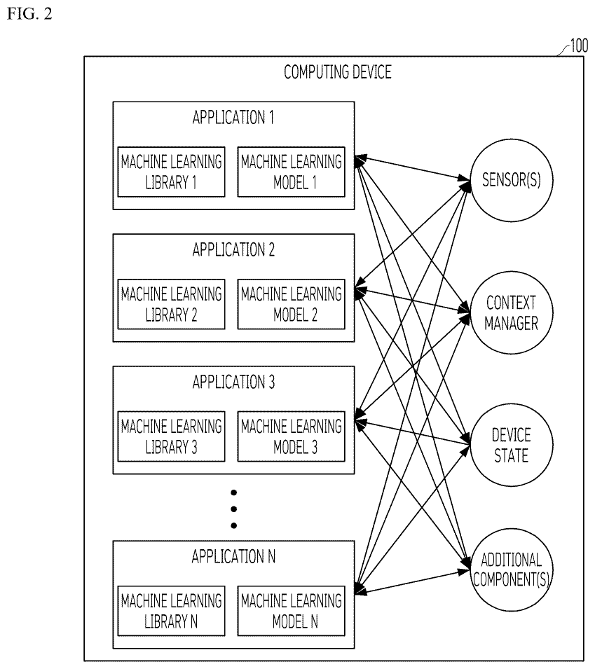

FIG. 2 illustrates a block diagram of a computing device implementing an MoE architecture-based model provision service according to an embodiment of the present disclosure.

Referring to FIG. 2, a computing device 100 included in the user computing device 110, the server computing system 130, and/or the training computing system 150 includes a plurality of applications (for example, application 1 to application N). Each application may include a machine learning library and at least one machine learning model. For example, the applications may include an image processing application (for example, an application for detection, classification and/or segmentation), a text messaging application, an e-mail application, a dictation application, a virtual keyboard application, a browser application, and a chat-bot application.

In an embodiment, the computing device 100 may include the model trainer 160 for training the artificial intelligence model, and may store and operate the trained artificial intelligence model to provide output data according to predetermined input data (in an embodiment, text, voice, image, moving picture, and/or specific sensor based sensing data).

Each application of the computing device 100 may communicate with another or other components of the computing device 100, such as, one or more sensors, a context manager, a device state component, and/or additional components. In an embodiment, each application may communicate with each device component using an Application Programming Interface (API) (for example, a public API). In an embodiment, the API used by each application may be specific to a relevant application.

FIG. 3 illustrates a block diagram of a computing device implementing an MoE architecture-based model provision service according to an embodiment of the present disclosure.

Referring to FIG. 3, a computing device 200 includes a plurality of applications (for example, application 1 to application N). Each application is in communication with a central intelligence layer. For example, the applications may include an image processing application, a text messaging application, an e-mail application, a dictation application, a virtual keyboard application, and a browser application. In an embodiment, each application may communicate with the central intelligence layer (e.g. model(s) stored therein) using an API (for example, a common API across all applications).

In addition, the central intelligence layer may include a plurality of machine learning models. For example, as illustrated in FIG. 3, a respective machine learning model or at least some of machine learning models may be provided for each application and managed by the central intelligence layer. In other implementations, two or more applications may share a single machine learning model. For example, in some implementations, the central intelligence layer may provide a single model for all of the applications. In other implementations, the central intelligence layer may be included in an operating system of the computing device 200 or implemented differently.

The central intelligence layer may communicate with a central device data layer. The central device data layer may be a centralized data storage for the computing device 200. As illustrated in FIG. 3, the central device data layer may communicate with another or other components of the computing device 200, such as, for example, one or more sensors, a context manager, a device state component, and/or additional components. In some implementations, the central device data layer may communicate with each device component using an API (for example, a private API).

The technologies and components discussed herein may be applied and make reference to servers, databases, software applications, and other computer-based systems, as well as actions taken and information sent to and from systems. The inherent flexibility of computer-based systems allows for a great variety of possible configurations, combinations, and divisions of tasks and functionality between and among components. For instance, processes discussed herein may be implemented using a single device or component or a plurality of devices or components working in combination. Databases and applications may be implemented on a single system or distributed across a plurality of systems. Distributed components may operate sequentially or in parallel.

### AI Agent Specialization Model (AIAM)

The computing system 1000 may include an AI agent specialization model (AIAM) according to an embodiment of the present disclosure.

The AIAM according to an embodiment may be an AI agent model to which the MoE architecture implemented according to an embodiment of the present disclosure is applied, and may be an artificial intelligence model including a data processing algorithm which may autonomously act in a specific environment, solve a task, and achieve a goal.

The AIAM may include a data processing algorithm for implementing a cognitive ability of collecting and interpreting data from a given environment, a decision mechanism of deciding an optimal action based on the collected data, an execution ability of executing the decided action, and a learning ability of improving the action through experience.

As an embodiment, the AIAM may receive input data in a predetermined format (for example, text, voice, image, moving picture, and/or specific sensor based sensing data), and output data (for example, response data responding to a specific query and/or a control signal according to a specific instruction) by performing a predetermined task based on the received input data.

For example, the input data may include a query of a user, and the computing system 1000 may identify a context of the user based on the query.

The context may include compound information such as previous questions, location, time, and/or preferences of a user.

Accordingly, the computing system 1000 may generate a final response to the query by considering the context described above.

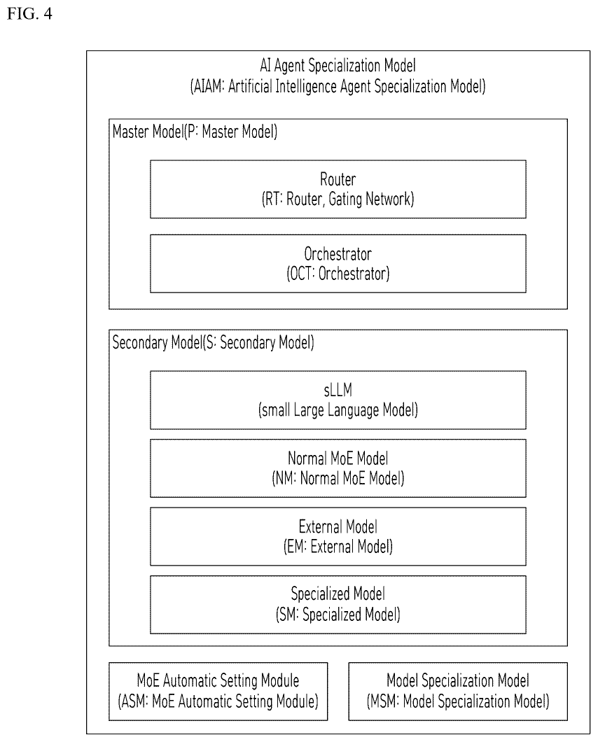

FIG. 4 illustrates a block diagram of an AI agent model according to an embodiment of the present disclosure.

Referring to FIG. 4, the AI agent model according to an embodiment may include one or more of a router (RT) (e.g., a gating network), orchestrator (OCT), small large language model (sLLM), normal MoE model (NM), external model (EM), and/or specialized model (SM).

In FIG. 4, the AI agent model includes one or more of the components described above in order to prevent a feature from being blurred.

However, in certain embodiments, other universal components other than the components illustrated in FIG. 4 may be further included or some components illustrated in FIG. 4 may be omitted.

For instance, the RT (e.g., a gating network) according to an embodiment of the present disclosure may comprise an artificial intelligence module that performs task allocation and/or traffic adjustment for a plurality of models in the MoE architecture.

Specifically, the RT may analyze given input data and/or a request task to decide which model is most appropriate to the corresponding data processing.

In an embodiment, the RT may decide a model optimized to the processing of given data based on the performance, specialty, and/or previous experience of each model.

Further, the RT may distribute the given task to one or more models by taking system load into account to ensure efficient data processing.

Moreover, the RT may adjust a task allocated to a specific model by flexibly responding to real-time system change.

In an embodiment, the RT may include an artificial intelligence module configured to selectively decide a model (hereinafter, referred to as a domain-specific specialized model) which executes a data processing operation optimized to a predetermined domain.

In other words, in an embodiment, the RT may comprise an artificial intelligence model which selects a model (e.g., a domain-specific specialized model) that is determined to perform data processing (for example, deep learning in an embodiment) most suitable for a given domain among the plurality of models included in the AIAM.

For reference, the domain according to an embodiment may be data, a rule, a terminology, a problem definition, and/or a process used to perform a task specified by a predetermined AI system.

In one embodiment, the RT performs data analysis based on a feature of predetermined input data (for example, a user input and/or specific sensing data) and/or a request task, understands a data processing feature optimized to the corresponding task based on the data analysis, and detects a predetermined model which implements the same to decide the domain-specific specialized model.

In other words, the RT according to an embodiment may comprise an artificial intelligence module configured to detect a model which may most effectively perform data processing according to a given domain, and allocate or distribute a corresponding task processing task.

The RT according to an embodiment may include a RT pre-trained according to a described predetermined algorithm, a RT additionally trained according to an embodiment, and/or a RT newly trained by a new scheme. A detailed description thereof is provided in the section of the MoE Model Providing Method below.

In addition, the RT according to an embodiment may further perform additional functional operations described in the section of MoE Model Providing Method below.

The OCT according to an embodiment of the present disclosure may include an artificial intelligence module configured to control and manage an overall configuration of the AIAM.

In detail, in an embodiment, the OCT may allocate various tasks generated in an entire system to an appropriate resource (for instance, the RT and/or a predetermined model in an embodiment).

Further, the OCT may manage resources such as a usable model and a hardware resource (for example, a CPU and/or a GPU) to be efficiently used.

Further, the OCT monitors performance of an entire system to adjust one or more specific parameters as necessary or optimize a network configuration.

Further, the OCT may manage interlocking between a plurality of RTs and/or models, and control a data flow and processing process.

In other words, in an embodiment, the OCT may perform control and management of an entire system of the AIAM, and perform a role of a main RT which controls at least one RT.

The OCT and the RT according to an embodiment are configured to operate in close coordination, thereby facilitating efficient operation of an MoE system.

Specifically, the OCT as a manager of an entire system may monitor the performance of the RT, and adjust a strategy of the RT as necessary.

The RT may implement efficient system control by substantially performing the allocation of the data processing task according to an instruction and/or a self-algorithm of the OCT.

In an embodiment, the OCT and/or the RT described above may comprise a master model P which may control and manage other components of the AIAM or an entire system (for example, the sLLM, the NM, the EM, and/or the SM).

The sLLM according to an embodiment of the present disclosure may include an artificial intelligence module implemented as a lightweight version of the LLM.

In other words, the sLLM may comprise an artificial intelligence module constructed to implement similar performance to a large model such as the LLM with a smaller number of resources.

In an embodiment, the sLLM may include an MoE model (for instance, MoELM in an embodiment) based on a combination of a plurality of SMs and RTs according to an embodiment of the present disclosure described in the section of MoE Model Providing Method below. Moreover, the sLLM may include the MoE model (e.g., a DMoE model in an embodiment) based on the domain-specific specialized model according to an embodiment of the present disclosure described in the section of MOE-Based Model Specifying Method below. A detailed description thereof is provided in the sections of MoE Model Providing Method and MoE-Based Model Specifying Method below.

Further, the NM according to an embodiment of the present disclosure may mean a predetermined MoE model implemented according to a described universal scheme.

For example, the NM may include a switch transformer, conditional computation in neural networks, sparse mixture of experts, and/or megatron-LM.

Further, the EM according to an embodiment of the present disclosure may be a predetermined artificial intelligence model implemented according to various described algorithms.

For example, the EM may include ChatGPT, Gemini, and/or Llama.

In an embodiment, the EM may be selectively used as necessary, and may support the processing of a given task.

Further, the SM according to an embodiment of the present disclosure may mean an artificial intelligence model in which optimized learning is performed for a specific purpose.

In other words, the SM may comprise an artificial intelligence model trained according to training data and a training scheme specialized to achieve a predetermined task.

The SM described throughout an embodiment of the present disclosure may correspond to a specific embodiment of an artificial intelligence model to which the technical ideas of an embodiment of the present disclosure may be applied.

Accordingly, the SM according to an embodiment of the present disclosure may include various artificial intelligence models with diverse structures and purposes.

In an embodiment, the SM may include a predetermined sLLM (such as MoELM and/or DMoE model), the NM, and/or the EM which is/are trained. Moreover, the SM may include a specialized module model according to an embodiment of the present disclosure described in the section of MoE-Based Model Specifying Method to be described later. A detailed description thereof will be described in the section of MoE-Based Model Specifying Method below.

In an embodiment, the sLLM, NM, EM, and/or SM described above may be a secondary model S which may perform a specific task according to control and management of the master model P (in other words, the OCT and/or the RT) of the AI agent model.

### MoE Model Providing Method

Hereinafter, a method for implementing a model provision service based on the MoE architecture that provides the MoE model based on a plurality of independently trained SMs by the computing system 1000 according to an embodiment of the present disclosure will be described in detail.

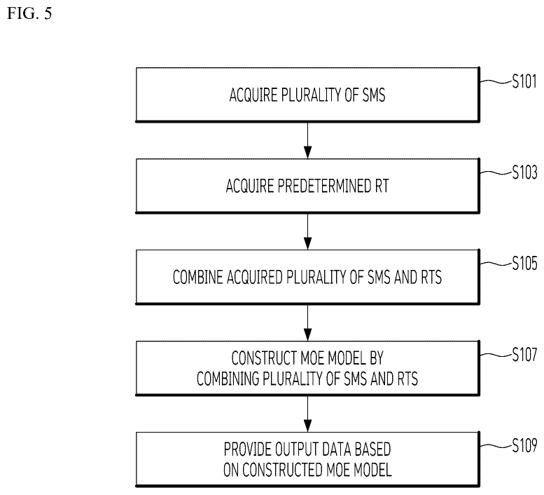

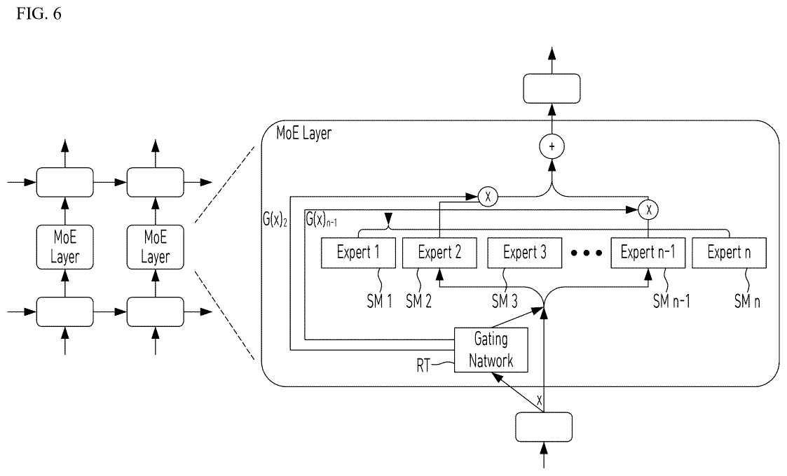

FIG. 5 illustrates a flowchart of a method of providing an MoE model according to an embodiment of the present disclosure. FIG. 6 illustrates a conceptual diagram of a method of providing an MoE model according to an embodiment of the present disclosure.

Referring to FIGS. 5 and 6, a method for implementing a model provision service based on an MoE architecture that provides an MoE model implemented based on a plurality of pre-trained SMs by the computing system 1000 according to an embodiment of the present disclosure may include: step S101 of acquiring a plurality of SMs; step S103 of acquiring a predetermined RT; step S105 of combining the acquired plurality of SMs and RTs; step S107 of constructing an MoE model by combining the plurality of SMs and RTs; and step S109 of providing output data based on the constructed MoE model.

At step S101, the computing system 1000 according to an embodiment of the present disclosure may acquire the plurality of SMs.

The SM according to an embodiment may include an artificial intelligence model optimized through learning for a specific purpose, and may refer to an artificial intelligence model that has been trained using training data and methods specialized for a relevant purpose.

In an embodiment, the SM may include a predetermined trained sLLM (including MoELM and/or DMoE models), the NM, the EM, and/or the specialized module model according to an embodiment of the present disclosure described in the section of MoE-Based Model Specifying Method described below.

In an embodiment, the computing system 1000 may obtain or-acquire the plurality of SMs based on user input and/or through interaction with external servers.

At step S103, the computing system 1000 according to an embodiment of the present disclosure may receive or acquire a predetermined RT.

The RT according to an embodiment may comprise an artificial intelligence module that performs task allocation and/or traffic adjustment for a plurality of models in the MoE architecture.

In an embodiment, the computing system 1000 may obtain or acquire at least one RT based on user input and/or through interaction with external servers.

The RT may include a RT pre-trained according to a described predetermined algorithm, a RT additionally trained according to an embodiment to be described later, and/or a RT newly trained by a new scheme.

At step S105, the computing system 1000 according to an embodiment of the present disclosure may combine the acquired plurality of SMs and RTs.

In an embodiment, the computing system 1000 may combine a plurality of independently trained SMs and RTs in a coordinated manner.

In detail, in an embodiment, the computing system 1000 may add the RT to the plurality of SMs and construct one model (hereinafter, MoELM) that operates like the MoE architecture of FIG. 6.

In other words, the computing system 1000 may configure a third MoE utilizing a modularized SM.

In an embodiment, the computing system 1000 may detect an input data type for each of the plurality of SMs.

In addition, the computing system 1000 may perform different combining processes depending on whether the detected input data types are identical.

For instance, in an embodiment, the computing system 1000 may combine the plurality of SMs and RTs by utilizing existing RTs when the input data types of the plurality of SMs are identical.

Specifically, in an embodiment, the computing system 1000 may combine the plurality of SMs and RTs by integrating the weight values of the existing RTs for each SM through a predetermined computation.

In an embodiment, the computing system 1000 may combine the plurality of SMs and RTs by using one or more methods such as simple summation, sampling and summation, and/or summation according to a specific formula set by a user of the weight values of the existing RTs for each SM.

Thus, the computing system 1000 may combine the plurality of independently trained SMs and RTs into one, without requiring separate additional training.

In an embodiment, when the input data types of the plurality of SMs differ, the computing system 1000 may combine the plurality of SMs and RTs by additionally training the existing RT.

Hereinafter, for efficient explanation, the plurality of SMs will be limited to a first SM and a second SM, but the present disclosure is not limited thereto.

In an embodiment, the computing system 1000 may train the RT to expand the input data types of the first SM and the second SM.

More specifically, the computing system 1000 may integrate the original form of the input data of the first SM and the original form of the input data of the second SM using a predetermined computation at the time of preservation.

In addition, the computing system 1000 may train the RT to use the input data type based on the integrated input data as the input data types of the first SM and the second SM.

In other words, the computing system 1000 may perform additional training on the RT to expand the input data types of the first SM and the second SM and perform learning and operation based thereon.

In another embodiment, the computing system 1000 may train the RT to change the input data types of the first SM and the second SM.

In detail, the computing system 1000 may transform the input data of the first SM into the input data type of the second SM by transforming the input data of the first SM into a weight value.

In addition, the computing system 1000 may then train the RT to use the transformed data values to train and operate the second SM.

In the same manner, the computing system 1000 may train the RT to train and operate the first SM by transforming the input data of the second SM into the input data type of the first SM and then using the transformed input data of the second SM.

In other words, the computing system 1000 may perform additional training on the RT to change the input data types of the first SM and the second SM and perform learning and operation accordingly.

As such, in an embodiment, the computing system 1000 may combine the plurality of SMs and RTs with additional training to address differences in input data types between the SMs, thereby preventing errors and constructing a combined model (e.g., MoELM) that performs smoother learning and operation.

In an embodiment, the computing system 1000 may combine the plurality of SMs and RTs by re-training the existing RT in a new way.

Specifically, in an embodiment, the computing system 1000 may perform RT learning to determine which input data to forward to which SM based on input data and/or available resources.

The computing system 1000 may also perform the RT learning to determine whether to forward all or only a portion of the input data.

Furthermore, in an embodiment, the computing system 1000 may perform the RT learning to determine how many SMs to activate based on input data and/or available resources.

Furthermore, in an embodiment, the computing system 1000 may perform the RT learning to determine the quality of output data and, based on the quality of output data, determine which input data to forward to which the SM.

Furthermore, in an embodiment, the computing system 1000 may perform the RT learning to determine data processing speed and/or performance and, based on the determined data processing speed and/or performance, determine which input data to forward to which the SM.

In addition, in an embodiment, the computing system 1000 may perform the RT learning, which determines the quality of data processing based on initial settings and, based on the quality of data processing, determine which input data to forward to which the SM.

Additionally, in an embodiment, the computing system 1000 may perform the RT learning to determine which input data should be forwarded to the SM based on target performance and data processing speed set according to user input.

Further, in an embodiment, the computing system 1000 may perform the RT learning, which allows the RT to independently determine the optimal SM based on user feedback, reinforcement learning, LLM-based self-feedback, RLHF, and/or RLAIF, and then forward the input data to the corresponding SM.

In addition, referring further to FIG. 4, in some embodiments, the computing system 1000 may further include an artificial intelligence module (hereinafter, referred to as an MoE automatic setting module (ASM)) that learns a predetermined existing MoE architecture and automatically sets a new MoE based on the predetermined existing MoE architecture.

In addition, the computing system 1000 may use the aforementioned MoE ASM to set learning and operations for the RT.

The MoE ASM may not perform any additional operations after completing the settings for the RT.

In addition, in some embodiments, the computing system 1000 may perform the RT learning that implements the functional operations of the aforementioned MoE ASM.

As such, in an embodiment, the computing system 1000 may execute a variety of new RT learning processes to smoothly combine the plurality of SMs and RTs.

Accordingly, the computing system 1000 may more reliably guarantee the performance and quality of the combined model (e.g., MoELM).

At step S107, the computing system 1000 according to an embodiment of the present disclosure may construct the MoE model by combining the plurality of SMs and RTs.

In an embodiment, the computing system 1000 may construct one model (e.g., MoELM) that operates like the MoE architecture by combining the plurality of SMs and RTs, as described above.

In some embodiments, the MoELM may be included in the sLLM according to an embodiment of the present disclosure.

In other words, the sLLM according to an embodiment may include an MoELM constructed according to an embodiment of the present disclosure.

At step S109, the computing system 1000 according to an embodiment of the present disclosure may provide output data based on the constructed MoE model.

In other words, in an embodiment, the computing system 1000 may use the MoELM constructed as described above to provide output data (for example, response data responding to a specific query and/or a control signal according to a specific instruction) in response to predetermined input data (for example, text, voice, image, moving picture, and/or specific sensor based sensing data).

As described above, in an embodiment, the computing system 1000 may combine separately trained SMs with the RT, operate the combined model (e.g., an MoE architecture), and provide output data accordingly.

In other words, the computing system 1000 may use a combined model (e.g., MoELM) constructed into an MoE format by collecting independently trained single models, generating and providing output data based on task processing based on predetermined input data.

Thus, in an embodiment, unlike conventional or existing MoE methods that operate while maintaining a large-sized overall model, the computing system 1000 may implement an MoE mechanism that utilizes small-sized models optimized for a given task, enabling efficient data processing without wasting unnecessary resources.

Thus, the computing system 1000 may support various services using an improved MoE model that maintains the advantages of the conventional MoE method (for example, faster pre-learning speed compared to FFN, faster inference speed compared to models of the same size, and/or improved instruction tuning performance) while reducing the limitations associated with conventional MoE methods (for example, the need for a high level of VRAM and/or various challenges in a fine tuning process), and thus may improve the performance and quality of the corresponding service.

### MoE Based Model Specifying Method

Hereinafter, a method in which the computing system 1000 according to an embodiment of the present disclosure implements the MoE architecture based model providing service which implements modularization for a predetermined SM within the MoE model will be described in detail.

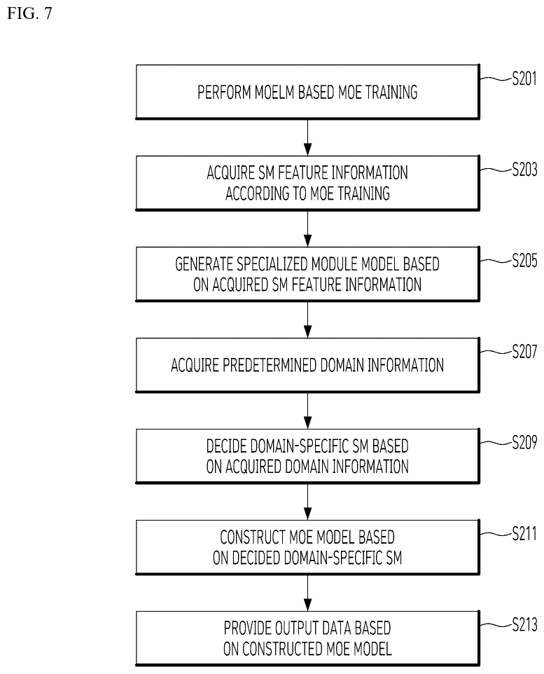

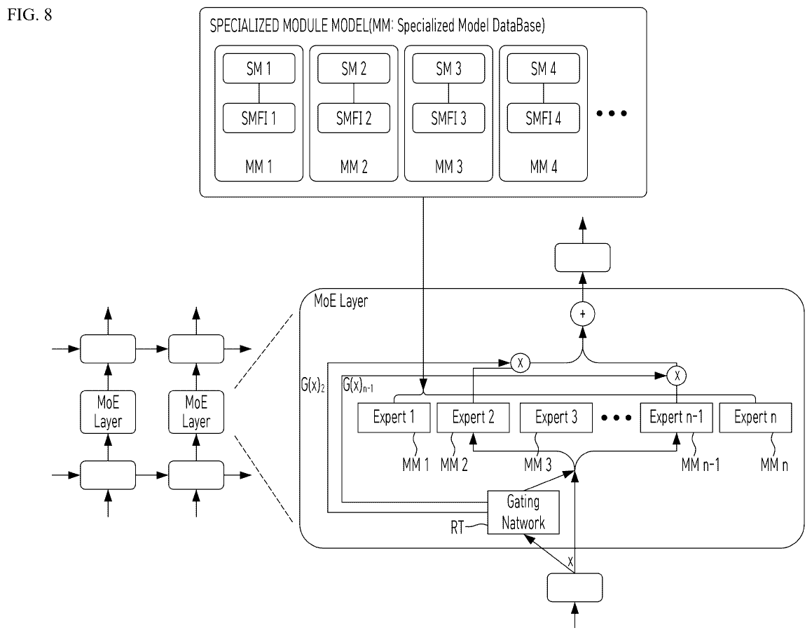

FIG. 7 illustrates a flowchart of a method for specifying a model based on an MoE according to an embodiment of the present disclosure. FIG. 8 illustrates a conceptual diagram of a method for specifying a model based on an MoE according to an embodiment of the present disclosure.

Referring to FIGS. 7 and 8, the method in which the computing system 1000 according to an embodiment of the present disclosure implements the MoE architecture based model providing service which implements modularization for the SM within the MoE model may include: step S201 of performing MoELM based MoE training; step S203 of acquiring SM feature information according to the MoE training; step S205 of generating a specialized module model based on the acquired SM feature information; step S207 of acquiring predetermined domain information; step S209 of deciding a domain-specific SM based on the acquired domain information; step S211 of constructing an MoE model based on the decided domain-specific SM; and step S213 of providing output data based on the constructed MoE model.

For a normalized pre-trained SM, it may be often challenging to identify or interpret which model is specialized to a specific domain.

As a result, there may be limitations in selecting and utilizing the SM that is most optimized to a specific task.

To address these limitations, in an embodiment of the present disclosure, the computing system 1000 may specify and modularize the roles and/or functions of each SM, and effectively select and utilize a customized SM optimized to a specific domain based on this process.

At step S301, the computing system 1000 according to an embodiment of the present disclosure may perform the MoELM based MoE training.

In an embodiment, the computing system 1000 may perform the MoE training using the MoELM constructed based on the MoE Model Providing Method described above.

As the training is performed, the computing system 1000 may train each of the plurality of SMs included in the MoELM.

In other words, as such training is performed, each of the plurality of SMs in the MoELM may be trained.

The SM according to an embodiment may be an artificial intelligence model optimized through learning for a specific purpose, and may mean an artificial intelligence trained according to training data and a training scheme specialized to a corresponding purpose.

In an embodiment, the SM may include a predetermined sLLM (such as MoELM and/or DMoE model), the NM, the EM and/or a specialized module model (MM).

At step S203, the computing system 1000 according to an embodiment of the present disclosure may acquire the specialized model feature information (SMFI) according to the MoE training.

The SMFI according to an embodiment may mean information specifying a role and/or a function of a predetermined SM.

In detail, referring further to FIG. 4, in an embodiment, the computing system 1000 may further include a model specialization module (MSM).

In addition, the computing system 1000 may acquire the aforementioned SMFI by interlocking with the MSM.

The MSM according to an embodiment of the present disclosure may include an artificial intelligence module configured to generate and output the SMFI corresponding to a predetermined SM based on the MoE training.

In an embodiment, the MSM may monitor and track a task allocation state of the RT to each SM when the aforementioned MoE training is performed.

In other words, in an embodiment, the MSM may understand which task the RT assigns or allocates to SM as the MoELM learns and operates.

In some embodiments, the MSM may generate, match, and manage a tag specifying each task allocation state for each tracked task allocation state.

Thus, in an embodiment, the MSM may determine a specialty for each of the plurality of SMs.

Further, in an embodiment, the MSM may generate the SMFI corresponding to each SM based on the determined specialty for each SM.

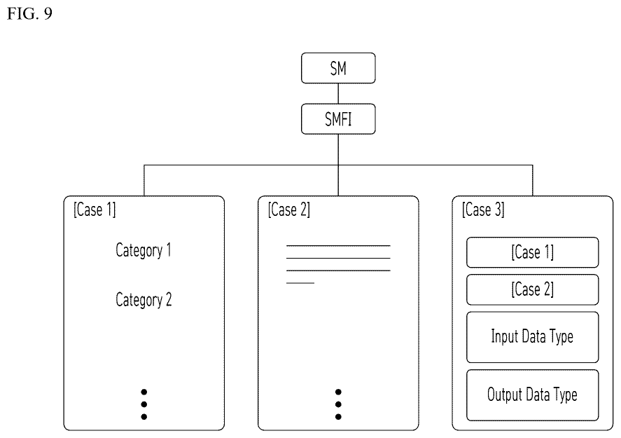

FIG. 9 illustrates an example of specialized model feature information (SMFI) according to an embodiment of the present disclosure.

Referring to FIG. 9, in an embodiment, the MSM may generate the aforementioned SMFI in at least one case of the following cases.
[Case 1] The SMFI takes a form of selecting one category from predetermined SM roles and/or functions specifying a category (for example, query and response or device control) based on a user input
[Case 2] The SMFI takes a form of specifying a role and/or a function of the SM in a natural language form
[Case 3] The SMFI takes a form of specifying a role and/or a function of the SM in at least one case of Case 1 or Case 2, and further defining input data and output data of the corresponding SM

In an embodiment, the MSM may provide the generated SMFI to the computing system 1000 as the output data.

Accordingly, in an embodiment, the computing system 1000 may obtain or acquire feature information for each SM by interacting with the MSM.

At step S205, the computing system 1000 according to an embodiment of the present disclosure may generate the specialized MM based on the acquired SMFI.

For example, the specialized MM according to an embodiment of the present disclosure may be an SM independently separated while conforming to a predetermined SMFI.

In detail, in an embodiment, the computing system 1000 may associate or match the SMFI acquired as described above with its corresponding SM.

Further, in an embodiment, the computing system 1000 may isolate or independently separate the SM associated or matched with the SMFI, and store the separated SM in a database.

In other words, in an embodiment, the computing system 1000 may perform the modularization of associating or matching a relevant SMFI with or to a respective SM, and separately distinguish, store, and manage the associated or matched SMFI.

Accordingly, the computing system 1000 may generate the specialized MM which is the SM independently separated while conforming to or matching with the SMFI.

As described above, in an embodiment, the computing system 1000 may identify or understand features for each SM within a given MoE model (e.g., MoELM in an embodiment), and reflect these features, and modularize each SM into a compact form that is reusable and sharable.

As a result, the computing system 1000 may sort and select the SM which implements a data processing process optimized to a specific domain rapidly and efficiently with higher accuracy, and easily support flexible scalability and reduction of the MoE model based thereon.

At step S207, the computing system 1000 according to an embodiment of the present disclosure may acquire predetermined domain information.

For example, the domain information according to an embodiment may be information defining a domain which specifies data, a rule, a terminology, a problem definition, and/or a process used to perform a predetermined task specified by a predetermined AI system.

In detail, in an embodiment, the computing system 1000 may acquire predetermined input data (for example, text, voice, image, moving picture, and/or specific sensor based sensing data).

Further, in an embodiment, the computing system 1000 may determine a domain corresponding to the acquired input data.

In an embodiment, a method in which the computing system 1000 determines the domain for the input data may be performed based on various described algorithms which are capable of performing the method, but the present disclosure is not limited thereto.

Accordingly, the system 1000 according to an embodiment may acquire domain information for a task to be processed.

At step S309, the computing system 1000 according to an embodiment of the present disclosure may determine a domain-specific specialized model based on the acquired domain information.

The domain-specific specialized model according to an embodiment may be an SM that executes a data processing (e.g., deep learning in an embodiment) optimized to a predetermined domain.

In detail, referring further to FIG. 8, in an embodiment, the computing system 1000 may determine at least one domain-specific specialized model based on the domain information and the SMFI acquired as described above.

More specifically, in an embodiment, the computing system 1000 may detect at least one SMFI having a feature corresponding to the acquired domain information.

For example, when identifying “a feature of a task which outputs response data to predetermined query data” based on the first domain information, the computing system 1000 may detect at least one SMFI specified as “a role and/or a function specialized to a query and a response”among the plurality of SMFIs stored in the database.

In certain embodiments, the computing system 1000 may detect at least one SMFI corresponding to the domain information based on a plurality of tags generated by the MSM for each task allocation state of the RT for the plurality of SMs upon the aforementioned MoE architecture based training.

In other words, in certain embodiments, the computing system 1000 compares the plurality of tags generated as described above with the domain information to detect at least one SMFI corresponding to the corresponding domain information.

In some embodiments, the computing system 1000 may filter a comparison target tag according to the generation time of each tag.

Specifically, the computing system 1000 may set, as the comparison target tag, at least one tag generated at a specific task allocation time according to a user input and/or a predetermined self process.

For example, the computing system 1000 may set, as the comparison target tag, at least one tag generated for a task allocation state performed after a predetermined time during an entire training time by considering that task allocation accuracy is enhanced as a training rate becomes higher.

Accordingly, the computing system 1000 compares at least one filtered tag with the domain information to ensure higher accuracy in detecting at least one SMFI corresponding to the domain information.

Further, in an embodiment, the computing system 1000 may extract the SM (for example, the specialized MM) associated or matched with each of detected SMFI.

In addition, in an embodiment, the computing system 1000 may determine at least one extracted specialized MM as the domain-specific specialized model.

At step S211, the computing system 1000 according to an embodiment of the present disclosure may construct an MoE model based on the decided domain-specific specialized model.

Referring further to FIG. 8, in an embodiment, the computing system 1000 may construct one model (hereinafter a “DMoE model”) which operates like the MoE architecture based on at least one domain-specific specialized model decided as described above.

In other words, the computing system 1000 may construct the MoE model (for example, the DMoE model) which implements data processing optimized to a specific domain by using at least some models (for example, a domain-specific specialized model) among the plurality of SMs modularized with a small size.

In detail, in an embodiment, the computing system 1000 combines at least one domain-specific specialized model and a predetermined RT to construct the aforementioned DMoE model.

In an embodiment, a specific method of constructing the DMoE model by combining the domain-specific specialized model and the RT using the computing system 1000 may be applied to the description of the method of constructing the MoELM by combining the plurality of SMs and RTs described in the section of MoE Model Providing Method described above.

Hence, in an embodiment, the computing system 1000 may construct the DMoE model including the domain-specific specialized model and the RT.

In an embodiment, the DMoE model may be included in the sLLM.

In other words, the sLLM according to an embodiment may include the DMoE model constructed according to an embodiment of the present disclosure.

At step S213, the computing system 1000 according to an embodiment of the present disclosure may provide output data based on the constructed MoE model.

In other words, in an embodiment, the AI agent specialization model (AIAM) may provide output data (for example, response data responding to a specific query and/or a control signal according to a specific instruction) for predetermined input data (for example, text, voice, image, moving picture, and/or specific sensor based sensing data) by using the DMoE model constructed as described above.

As described above, in an embodiment, the computing system 1000 may identify or specify roles and/or functions of each SM, and separate and modularize each specified role and/or function to a level to be reusable and sharable, and construct a customized MoE model (for example, the DMoE model) optimized to a specific domain rapidly and flexibly by utilizing the role and/or function, and provide predetermined output data according to efficient task processing using the constructed model.

Accordingly, in an embodiment, the computing system 1000 may implement and provide the MoE model having further enhanced data processing and/or computation speed and inference performance, and support various services through the MoE model to effectively achieve performance and quality enhancement.

### MoE Application LLM Based AI Agent Providing Method

Hereinafter, a method in which the computing system 1000 according to an embodiment of the present disclosure decides an application model optimized to a domain according to an external environment based on an LLM which applies an MoE, and implements an MoE architecture based model providing service which provides an on-device specialized AI agent performing an output based on the decided application model will be described in detail.

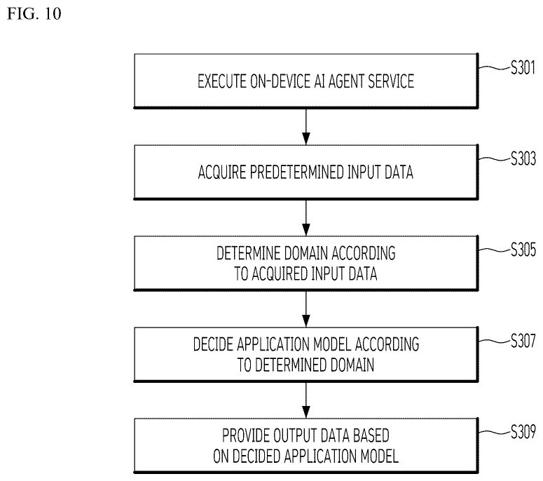

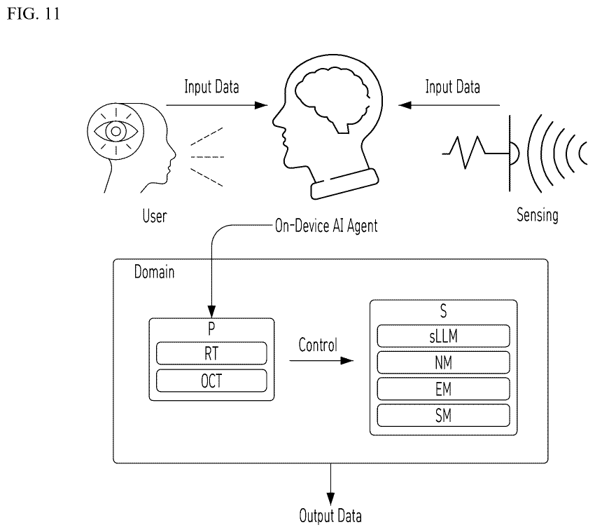

FIG. 10 illustrates a flowchart of a method for providing an AI agent based on an LLM applying an MoE according to an embodiment of the present disclosure. FIG. 11 illustrates a conceptual diagram of a method for providing an AI agent based on an LLM applying an MoE according to an embodiment of the present disclosure.

Referring to FIGS. 10 and 11, a method in which the computing system 1000 according to an embodiment of the present disclosure decides an application model optimized to a domain according to external environment based on an LLM which applies an MoE, and implements an MoE architecture based model providing service which provides an on-device specialized AIAM performing output based on the decided application model may include: step S301 of executing an on-device AI agent service; step S303 of acquiring predetermined input data; step S305 of determining a domain according to the acquired input data; step S307 of deciding an application model according to the determined domain; and step S309 of providing output data based on the decided application model.

At step S301, the computing system 1000 according to an embodiment of the present disclosure may execute the on-device AI agent service.

The on-device AI may be a technology that performs AI based data processing in a device of a user other than a cloud and/or an external server. Since the on-device AI performs or completes all processing in the device of the user without sending data to the outside of the device of the user or relying on the cloud or external server, the on-device AI may provide advantages such as enhanced personal information protection, real-time processing, and reduced dependence on Internet connectivity.

Accordingly, the on-device AI agent service may be various services implemented by utilizing the on-device AI.

For example, the on-device AI agent service may include smart phone's voice assistant services (for example, Google Assistant, Apple Siri, or Samsung Bixby), smart camera services (for example, HDR+ of Google Pixel, or Deep Fusion of Apple), fitness tracker and smartwatch services (for example, Apple Watch, or Fitbit), autonomous driving services (for example, Autopilot of Tesla), and/or home security services (for example, Nest Secure, or Ring).

In an embodiment, the computing system 1000 may execute a predetermined on-device AI agent service by interacting with the AIAM according to an embodiment of the present disclosure and/or a predetermined application.

At step S303, the computing system 1000 according to an embodiment of the present disclosure may acquire predetermined input data.

For instance, the computing system 1000 may acquire at least one input data (for example, predetermined text, voice, image, moving picture, and/or sensing data) based on a user input and/or by interacting with an external device (for example, a predetermined sensor) based on the on-device AI agent service executed as described above.

In an embodiment, the input data acquired as described above may include predetermined data which may specify a target task of data processing.

At step S305, the computing system 1000 according to an embodiment of the present disclosure may determine a domain according to the acquired input data.

For instance, the domain according to an embodiment may mean data, rule, terminology, problem definition, and/or process used to perform a task specified by a predetermined AI system.

In detail, in an embodiment, the computing system 1000 may determine a domain corresponding to the acquired input data.

In an embodiment, a method in which the computing system 1000 determines the domain for the input data may be implemented using various described algorithms which are capable of performing this function; however, in an embodiment of the present disclosure, the specific algorithm employed is not limited or restricted.

Accordingly, in an embodiment, the computing system 1000 may acquire domain information for a task to be processed.

At step S307, the computing system 1000 according to an embodiment of the present disclosure may decide an application model according to the determined domain.

The application model according to an embodiment may include a model which performs predetermined task processing according to given input data.

In an embodiment, the application model may comprise at least one model of secondary models S described above.

The secondary model S according to an embodiment may include a model which may perform a specific task according to control and management of the master model P (for example, the OCT and/or the RT) which is in charge of control and management of a predetermined AI system operation.

In an embodiment, the secondary model S may include one or more of the sLLM (including the MoELM and/or DMoE model), the NM, the EM, and/or the SM (including the specialized MM).

In detail, in an embodiment, the computing system 1000 may decide at least one application model based on the domain information acquired as described above.

In more detail, in an embodiment, the computing system 1000 may detect at least one model (for example, a domain-specific specialized model) which executes a data processing operation (e.g., deep learning in an embodiment) optimized to given domain information among the secondary models S described above by interacting with the master model P (e.g., the OCT and/or the RT) according to an embodiment of the present disclosure.

The description regarding a method in which the computing system 1000 detects the domain-specific specialized model by interacting with the master model P is omitted herein, as the description for the RT and the OCT in the section of [AI Agent Specialization Model (AIAM) can be applied to this method.

Further, in an embodiment, the computing system 1000 may decide at least one detected domain-specific specialized model as the application model.

At step S309, the computing system 1000 according to an embodiment of the present disclosure may provide output data based on the decided application model.

In an embodiment, the computing system 1000 may generate and provide output data (for example, response data responding to a specific query and/or a control signal according to a specific instruction) for predetermined input data (for example, text, voice, image, moving picture, and/or specific sensor based sensing data) based on at least one application model decided through the AIAM as described above.

In other words, the computing system 1000 may perform a predetermined request task based on given input data by using the application model decided as described above, and provide output data according to the performed data processing.

In an embodiment, the computing system 1000 may provide the output data based on the on-device AI agent service described above.

In one embodiment, the computing system 1000 may use the aforementioned MoELM as the application model to process a task requiring compound reasoning, and transmit and provide the resulting output data to a predetermined user computing device 110.

For example, the computing system 1000 may receive a compound query from a user, such as “Find restaurants near my current location that are open for business now and offer vegetarian menus, and tell me the optimal route to the restaurant with the highest social media ratings,”through the on-device AI agent.

The computing system 1000, which receives a query requiring the compound reasoning, may decompose the compound query into logical sub-tasks via the RT included in the MoELM, such as (1) a task of understanding the current location, (2) a task of searching for nearby restaurant information, (3) a task of checking the menu and business hours of each restaurant, (4) a task of comparing social media ratings, (5) a task of calculating a route to the final destination, and (6) a task of generating an answer by synthesizing all collected information.

Subsequently, the computing system 1000 may selectively activate one or more of the plurality of SMs based on features of each sub-task decomposed via the RT.

For example, the computing system 1000 may sequentially or in parallel allocate and operate a “location information specialized model” for acquiring location information, a “web search specialized model” for searching restaurant information, a “map and route finding specialized model” for calculating routes, and a “natural language processing sLLM” for generating final answers.

The “location information specialized model” and the “web search specialized model” may correspond to specific embodiments of the SM described throughout the detailed description of the present disclosure.

As an example, the plurality of SMs may include various models (e.g., search models) that acquire information from external data sources.

The external data source may encompass any information source external to the model, such as a web, a database, an API, and/or a local file system.

For example, the search model may be an artificial intelligence model that accesses external data sources, such as a web, a specific database, an API, and/or a local file system, and searches for necessary information.

As another example, the plurality of SMs may include various models (e.g., augmentation models) that utilize searched information to reinforce generation of a final response.

For example, the augmentation model may be an artificial intelligence model that performs retrieval-augmented generation (RAG), which enhances the accuracy and detail of the response based on the latest information or factual data acquired by the search model.

The computing system 1000 may use a combined model, constructed in the form of a MoE by aggregating independently trained individual models, to oversee the entire reasoning process under the control of the RT and/or the OCT, such as by forwarding an output of SM performing one of a plurality of sub-tasks as input to the SM performing the next sub-task.

Accordingly, the computing system 1000 may synthesize the output data of the SMs that performed the plurality of sub-tasks to generate the final output data, thereby providing a user with the results of the compound task.

The above method is not limited to the examples described above and may be widely applied to various compound reasoning-based services, such as complex travel planning, product comparison and recommendation, and multi-condition search.

Furthermore, in this connection, in an embodiment, the computing system 1000 may ingest the final output data (or response) generated as described above into at least one subsequent processing component.

For example, the subsequent processing component may refer to a functional unit that receives data generated by at least one processor and performs a predetermined subsequent processing, and may be implemented using hardware, software, and/or a combination thereof.

The subsequent processing component may include a user interface generation component for manifesting output data (or response) through a user interface, a data storage component for storing the output data (or response) in a database in a specific format, and/or a visualization processing component for visualizing the output data (or response).

In some embodiments, the subsequent processing component may process and manifest the output data (or response) in the form of a table and/or graph on a graphical user interface (GUI) of the user computing device 110.

Furthermore, the computing system 1000 may operate in a hybrid manner, combining on-device processing with processing via an external model, wherein the selection and allocation of processing resources are dynamically determined based at least in part on current system load and available resources.

For example, in on-device environments such as automobiles or mobile phones, real-time performance and immediate response are important, but available computational resources (for example, CPU, GPU, or memory) may be limited.

Under such situations, the computing system 1000 may comprehensively determine the complexity of the input task, the system load of the current device, and the network connection status through a built-in master model P (for example, the RT and/or the OCT).

When it is determined that a task is relatively simple and can be sufficiently processed using on-device resources alone (for example, a simple query like “Find the nearest gas station”), the computing system 1000 may directly execute the determined application model (for example, the DMoE model) on-device to quickly provide results with reduced latency.

This may allow the computing system 1000 to reduce or minimize unnecessary communication with external servers, enhance data privacy, and ensure fast response times.

In contrast, when a task requires extensive computation (for example, a complex query like “Analyze driving records for the past month and create a report suggesting ways to improve fuel efficiency”) or available resources of the current device are insufficient, the computing system 1000 may decide to transmit a relevant task to the server computing system 130 in which the EM with more powerful computational capabilities is located via the network 170 for processing.

The computing system 1000 may then receive the processed results from the server computing system 130 and provide the final output data to a user.

Through this hybrid processing method, the computing system 1000 may increase or maximize task processing efficiency and flexibility by selecting an optimal computational method according to a situation without degrading the user experience, even in an on-device environment with limited resources.

As described above, in an embodiment, the computing system 1000 may effectively decide a model optimized to data processing according to a given domain even in an on-device environment based on the AIAM including the models (e.g., the MoELM, the DMoE model, and/or the specialized MM in an embodiment) implemented by applying the MoE architecture, and provide an output according to efficient data processing through the decided model according to an embodiment of the present disclosure.

The computing system 1000 may implement and provide an artificial intelligence model (for example, the AIAM) that is adapted to more accurately interpret tasks, executes tasks with improved efficiency, and generate responsive outputs across a wide range of operating environment.

Accordingly, in an embodiment, the computing system 1000 may enhance qualities and performances of various AI agent based services (for example, smart phone's voice assistant services, smart camera services, fitness tracker and smartwatch services, autonomous driving services, and/or home security services).

The embodiments of the present disclosure described above may be implemented in the form of program commands which may be executed through various types of computer constituting elements and recorded in a computer-readable recording medium. The computer-readable recording medium may include program commands, data files, and data structures separately or in combination thereof. The program commands recorded in the computer-readable recording medium may be those designed and configured specifically for the present disclosure or may be those commonly available for those skilled in the field of computer software. Examples of a computer-readable recoding medium may include magnetic media such as hard-disks, floppy disks, and magnetic tapes; optical media such as CD-ROMs and DVDs; and hardware devices specially designed to store and execute program commands such as ROM, RAM, and flash memory. Examples of program commands include not only machine codes such as those generated by a compiler but also high-level language codes which may be executed by a computer through an interpreter and the like. The hardware device may be replaced with by one or more software modules to perform the operations of the present disclosure, and vice versa.

Specific executions described in the present disclosure are exemplary embodiments and the scope of the present disclosure is not limited even by any method. For brevity of the specification, descriptions of conventional electronic configurations, control systems, software, and other functional aspects of the systems may be omitted. Further, connection or connection members of lines among components exemplarily represent functions connections and/or physical or circuitry connections and may be represented as various functional connections, physical connections, or circuitry connections which are replaceable or added in an actual device. Further, unless otherwise specified, such as “essential” or “important,” the connections may not be components particularly required for application of the present disclosure.

Further, in the detailed description of the present disclosure, which is described, while the present disclosure has been described with respect to the preferred embodiments, it will be understood by those skilled in the art or those skilled in the art having ordinary knowledge in the technical field that various changes and modifications of the present disclosure may be made without departing from the spirit and the technical scope of the invention described in the following claims. Accordingly, the technical scope of the present disclosure should not be limited to the contents described in the detailed description of the present disclosure but should be defined by the claims.

An embodiment of the present disclosure relates to a method and system for providing an AI agent based on an LLM applying an artificial intelligence model including a plurality of models, and is applicable to the artificial intelligence industry, and thus has industrial applicability.

What is claimed is:

1. A computer-implemented method, comprising:
executing, by at least one processor, an on-device artificial intelligence (AI) agent service;
accessing, by the at least one processor, at least one memory to load input data based on the executed on-device AI agent service from the at least one memory;
determining, by the at least one processor, at least one domain corresponding to the loaded input data;
deciding, by the at least one processor, at least one application model, which is an AI model that will process a task according to the determined at least one domain;
activating the at least one application model decided to process the task according to the determined at least one domain;
generating, by the at least one processor, output data for the input data based on the activated at least one application model; and
manifesting, by the at least one processor, the generated output data based on the on-device AI agent service.

2. The computer-implemented method of claim 1, wherein the input data specifies the task according to the domain in form of at least one of text, voice, image, video, or sensing data.

3. The computer-implemented method of claim 1, wherein the domain specifies at least one feature of data, a rule, a terminology, a problem definition, or a process for a predetermined task.

4. The computer-implemented method of claim 1, wherein the deciding of the at least one application model comprises deciding at least one master model, configured to control an on-device AI agent service system configured to store and execute the on-device AI agent service, to decide the at least one application model.

5. The computer-implemented method of claim 4, wherein the at least one master model comprises at least one of a router, which performs task allocation for each of at least one AI model included in the on-device AI agent service system based on the decided domain, or a orchestrator that controls the router.

6. The computer-implemented method of claim 5, wherein the deciding of the at least one application model further comprises deciding at least one secondary model, configured to perform a predetermined task under control of the at least one master model, to decide the at least one application model.

7. The computer-implemented method of claim 6, wherein the at least one secondary model comprises at least one of a small large language model (sLLM), a normal mixture of experts (MoE) model, a external model, or a specialized model.

8. The computer-implemented method of claim 7, wherein the sLLM comprises at least one AI model comprising the specialized model, which is an independently pre-trained artificial intelligence model, and the router, which is an AI module configured to control a model task.

9. The computer-implemented method of claim 7, wherein the specialized model comprises at least one specialized module model, which is an independently modularized specialized model, associated with specialized model feature information acquired based on learning based on the at least one artificial intelligence model comprising the at least one specialized model and the router.

10. The computer-implemented method of claim 9, wherein the sLLM comprises at least one AI model comprising the specialized module model and the router.

11. The computer-implemented method of claim 7, wherein the deciding of the at least one secondary model comprises:
deciding the at least one secondary model optimized for task processing according to the domain based on the at least one master model.

12. The computer-implemented method of claim 1, wherein the deciding of the at least one application model includes deciding a plurality of secondary models based on the domain determined by at least one master model, configured to control an on-device AI agent service system configured to store and execute the on-device AI agent service, to decide the at least one application model.

13. The computer-implemented method of claim 12, wherein:
the decided at least one application model includes a plurality of decided application models, and
the generating of the output data comprises operating the plurality of decided application models sequentially or in parallel and integrating outputs of the plurality of decided application models to generate final output data.

14. The computer-implemented method of claim 1, wherein the generating of the output data comprises selectively performing on-device processing for the input data using the decided at least one application model or transmitting, through a network, a request to an external model to perform processing for the input data based on load of an on-device AI agent service system configured to store and execute the on-device AI agent service and/or an available resource for the task in the on-device AI agent service system.

15. The computer-implemented method of claim 6, wherein the at least one master model is configured to decompose a query into a plurality of sub-tasks in response to the query requiring compound reasoning, and decide one of the at least one secondary model as the at least one application model based on features of the decomposed plurality of sub-tasks.

16. The computer-implemented method of claim 15, wherein the manifesting of the generated output data based on the on-device AI agent service comprises:
inputting an output of an application model, which performed one of the plurality of sub-tasks, to another application model, which performed a next sub-task of the plurality of sub-tasks; and
synthesizing outputs of a plurality of application models which are included in the at least one application model and performed the plurality of sub-tasks to generate final output data.

17. The computer-implemented method of claim 1, wherein the at least one application model comprises at least one of a search model configured to search for information from an external data source or an augmentation model configured to reinforce generation of a response.

18. A system comprising:
at least one memory configured to store instructions that are executable; and
at least one processor configured to provide an artificial intelligence (AI) agent based on an large language model (LLM) applying at least one of a plurality of AI models by executing one or more of the instructions to perform operations comprising:
executing an on-device AI agent service;
accessing the at least one memory to load input data based on the executed on-device AI agent service from the at least one memory;
determining at least one domain corresponding to the loaded input data;
deciding at least one application model, which is an AI model that will process a task according to the determined at least one domain;
activating the at least one application model decided to process the task according to the determined at least one domain;
generating output data for the input data based on the activated at least one application model; and
manifesting the generated output data based on the on-device AI agent service.
